(19) United States
(12) Patent Application Publication
(10) Pub. No.: US 2023/0162476 A1
(43) Pub. Date: May 25, 2023

(54) METHOD AND SYSTEM FOR DETERMINING RISK IN CONSTRUCTION SITE BASED ON IMAGE ANALYSIS

(71) Applicant: SMARTINSIDE AI Inc., Suwon-si (KR)

(72) Inventors: Tae Heon KIM, Goyang-si (KR); Joo Ho SHIN, Anyang-si (KR); Seung Hee PARK, Seongnam-si (KR)

(73) Assignee: SMARTINSIDE AI Inc., Suwon-si (KR)

(21) Appl. No.: 18/072,715

(22) Filed: Dec. 1, 2022

Related U.S. Application Data
(63) Continuation-in-part of application No. 17/877,859, filed on Jul. 29, 2022.

(30) Foreign Application Priority Data
Oct. 12, 2021 (KR) 10-2021-0135121

(51) Int. Cl. G06V 10/764; G06V 10/20

(52) U.S. Cl. CPC G06V 10/764; G06V 10/255

(57) ABSTRACT

According to an aspect of the present invention, there is provided a method by which an analysis server determines a risk in a construction site based on image analysis, the method including the steps of: (a) acquiring an image, taken in a construction site, from an image acquisition device; (b) identifying one or more workers in the image, and grouping the workers based on identifiers that the respective workers have; and (c) determining whether protective equipment required to be worn for each group of workers has been correctly worn by analyzing the image.

### CROSS-REFERENCE TO RELATED APPLICATION

This application is a continuation of U.S. application Ser. No. 17/877,859 field Jul. 29, 2022, which claims under 35 U.S.C. § 119(a) the priority benefit of Korean Patent Application No. 10-2021-0135121 filed on Oct. 12, 2021, the disclosures of all application of which are hereby incorporated by reference.

### BACKGROUND

### Technical Field

The present invention relates generally to a method and system for determining a risk in a construction site based on image analysis, and more particularly to a method and system that enable the classification of workers and the determination of a risk for each worker based on a mobile image acquisition device.

### Description of the Related Art

Technologies for diagnosing the work safety of workers and determining risks in construction sites are being developed. In spite of these efforts, the accident rate and the death rate in construction sites are not decreasing, and a solution thereto is required.

Recently, the installation of closed-circuit televisions (CCTVs) has been made compulsory even in small- and medium-sized private construction sites, and the efficiency of safety management can be improved through the utilization of such CCTVs.

However, each construction site contains various processes depending on construction stages, so that the difficulty of image recognition in construction sites is higher than those of other fields of application. Accordingly, it is difficult to expect complete efficiency improvement even using CCTVs.

Accordingly, cases where image analysis is utilized along with a sensor combined with IoT technology in a complementary manner have emerged.

For example, a technology for preventing collisions between pieces of equipment used in construction sites and identifying the locations of workers via sensors such as beacons has emerged. However, this technology is problematic in that it is difficult to combine this technology with image analysis, multiple APs need to be installed when this technology is applied to an actual construction site, and each worker needs to wear protective gear with an IoT sensor attached thereto.

Meanwhile, the most common type of accidents in construction sites are falls of workers. The most common reason for this type of accidents is the inappropriate wearing of personal protective equipment.

Therefore, there is a need for a technology that can appropriately detect the wearing of personal protective equipment and efficiently manage safety in construction sites.

### SUMMARY

Objects of the present invention are to solve the problems of the related arts described above.

An object of the present invention is to group workers working in a construction site, determine protective equipment required to be worn for each group of workers, and determine whether each worker has worn the protective equipment required to be worn for the group of workers.

Another object of the present invention is to, in a construction site, determine safety and risk factors for each group of workers, recognize each work area, and determine a departure from the work area.

Objects of the present invention are not limited to the objects described above, and other objects not described above will be clearly understood from the following description.

According to an aspect of the present invention, there is provided a method for determining a risk in a construction site based on image analysis by which an analysis server comprising a processor and a memory comprising one or more sequences of instructions which, when executed by the processor, causes steps to be performed comprising: storing an image in the memory, taken in a construction site, from an image acquisition device; extracting a feature information from the image and classifying as each group of workers using the feature information based on a machine learning model; determining whether at least one of a safety factor and a risk factor required to be disposed in a work space has been disposed based on a type of work for each group of workers in the image, if there is no the safety factor or there is the risk factor in the work space, preparing a warning information so that the worker is able to perceive the warning information; and determining whether there is a departure from a work area for each group of workers based on information about the work area for each group of workers in the image, if a worker who departs from a first work area, moves to a second work area, preparing a message so that the worker wears protective equipment required according to the work area, wherein the protective equipment is required differently depending on the work area.

The feature information may include at least one of a color of protective gear worn by the worker or a color of protective equipment in the image.

The machine learning model may be trained with at least two data sets having different environments except for the feature information in the image.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing the schematic configuration of a system for determining a risk in a construction site based on image analysis according to an embodiment of the present invention; and

FIG. 2 is a block diagram illustrating the detailed configuration and operation of an analysis server according to an embodiment of the present invention.

FIG. 3 shows a schematic diagram of a system for implementing one or more aspects of the present disclosure.

### DETAILED DESCRIPTION

The following detailed description of the present invention will be given with reference to the accompanying drawings illustrating the specific embodiments in which the present invention can be practiced as examples. These embodiments are described in sufficient detail to enable those skilled in the art to practice the present invention. It should be understood that various embodiments of the present invention are different from each other but do not need to be mutually exclusive. For example, the specific shapes, structures, and/or features described herein may be implemented in other embodiments without departing from the spirit and scope of the invention. Furthermore, it should be understood that the locations or arrangement of individual components within each disclosed embodiment may be changed without departing from the spirit and scope of the present invention. Accordingly, the following detailed description is not intended to be taken in a limiting sense, and the scope of the present invention is limited only by the attached claims together with all equivalents to the claims. In the drawings, like reference numerals refer to the same function or a similar function throughout the various aspects.

In the following description, in order to enable those of ordinary skill in the art to easily practice the present invention, embodiments of the present invention will be described in detail with reference to the accompanying drawings.

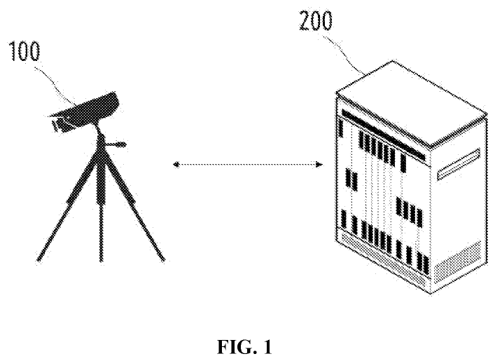

FIG. 1 is a diagram showing the schematic configuration of a system for determining a risk in a construction site based on image analysis according to an embodiment of the present invention.

Referring to FIG. 1, the system for determining a risk in a construction site based on image analysis according to the present embodiment may include an image acquisition device 100 and an analysis server 200.

The image acquisition device 100 and the analysis server 200 may communicate with each other over an intercommunication network, e.g., a LoRa network, a mobile communication network, a local area network (LAN), a metropolitan area network (MAN), a wide area network (WAN), the World Wide Web (WWW), and/or a Wireless Fidelity (Wi-Fi) network.

The image acquisition device 100 may be implemented as a mobile closed-circuit television (CCTV), but is not limited thereto. Any device having an image acquisition function may be used as the image acquisition device 100. A plurality of such image acquisition devices 100 may be disposed in a construction site. For example, the image acquisition devices 100 may be disposed at respective key positions such as an entrance door.

The image acquisition device 100 serves to acquire an image of a scene included in the field of view while moving through a construction site and then send the image to the analysis server 200. Furthermore, the image acquisition device 100 may include a location detection sensor, e.g., a GPS sensor, a GNSS sensor, or the like. When an image is sent to the analysis server 200, information about the location at which the image is acquired may be sent together with the image.

The analysis server 200 analyzes image information collected from the image acquisition device 100, identifies each worker, determines whether the worker has worn protective equipment, and determines whether the worker departs from a work area.

The analysis server 200 may include a memory to store collected image information and a processor to analyze the image information stored in the memory. The processor determines whether the worker has worn protective equipment and determines whether the worker departs from a work area. In embodiments, the processor may access the memory and execute commands stored in the memory or one or more sequences of instructions to control the operation of the server 200. The commands or sequences of instructions may be read in the memory from computer-readable medium or media such as a static storage or a disk drive, but is not limited thereto. In alternative embodiments, a hard-wired circuitry which is equipped with a hardware in combination with software commands may be used. The hard-wired circuitry can replace the soft commands. The instructions may be an arbitrary medium for providing the commands to the processor and may be loaded into the memory.

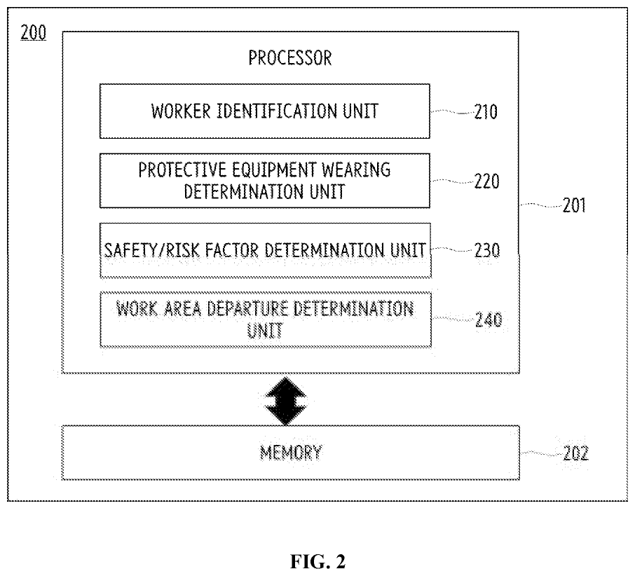

FIG. 2 is a block diagram illustrating the detailed configuration and operation of an analysis server 200 according to an embodiment of the present invention.

Referring to FIG. 2, the analysis server 200 according to the present embodiment may include a processor 201 and a memory 202.

The processor 201 may include a worker identification unit 210, a protective equipment wearing determination unit 220, a safety/risk factor determination unit 230, and a work area departure determination unit 240.

The worker identification unit 210, the protective equipment wearing determination unit 220, the safety/risk factor determination unit 230, and the work area departure determination unit 240 may be program modules or hardware capable of communicating with an external device. The program modules or hardware may be included in the processor 201 in the form of an operating system, one or more application program modules, or/and one or more program modules, and may be physically stored in various known storage devices. Meanwhile, the program modules or hardware include, but are not limited to, one or more routines, one or more subroutines, one or more programs, one or more objects, one or more components, one or more data structures, and/or the like that perform a specific task to be described later or execute a specific abstract data type to be described later according to the present invention.

The worker identification unit 210 serves to identify a worker by analyzing an image received from the image acquisition device 100 And stored in the memory 202. The identification of a worker may be performed based on the color of protective gear, e.g., a safety helmet, worn by the worker. As another example, the identification of a worker may be performed based on the color of protective equipment worn by the worker, or a symbol, a code, or the like attached to or marked on the protective equipment. To this end, in an image analysis process, a worker, and protective equipment worn by the worker, e.g., a safety helmet, may be recognized, and the color of the recognized protective equipment, or an identifier such as a symbol or code attached to the protective equipment may be determined. In other words, in the present specification, the identifier for the identification of a worker may be implemented as any identification tool attached to or worn on the body of the worker.

In a construction site, a worker may have an identifier that varies depending on the company to which the worker belongs, the type of work that is performed by the worker, or the location within the construction site at which the worker works. The worker identification unit 210 performs the operation of grouping workers based on identifiers.

The protective equipment wearing determination unit 220 serves to determine whether each worker identified by the worker identification unit 210 has worn protective equipment.

To this end, in image analysis, the recognition of protective equipment worn by each worker may be performed.

The workers grouped by the worker identification unit 210 may have different types of protective equipment required to be worn for respective groups. The protective equipment wearing determination unit 220 according to an embodiment may analyze whether each worker has worn protective equipment required for each group.

According to an embodiment, protective equipment required to be worn for each color of a safety helmet may be as follows:

TABLE 1

| | Color of | |
|---|---|---|
| | Safety | |
| Group | Helmet | Protective Equipment required to be worn |
| A | orange | safety gloves a, safety |
| | | shoes a, safety vest a |
| B | red | safety gloves b, safety shoes b, |
| | | safety vest a, safety mask a |
| C | pink | safety gloves c, safety shoes c, |
| | | safety vest b, safety mask b |
| D | yellow | safety gloves d, safety shoes d, |
| | | safety vest a, safety loop |
| E | blue | safety gloves e, safety shoes e, |
| | | safety vest a, earplugs, goggles |
| F | black | safety gloves f, safety shoes b, |
| | | safety vest a, safety mask c |

In the above table, the color of a helmet represents an example of an identifier for identifying a group of workers. Protective equipment required to be worn for each group is only an example. Safety gloves ‘a’ to ‘f’ refer to different types of safety gloves. The same is applied to safety shoes, safety vests, and safety masks.

In other words, the protective equipment required to be worn may vary depending on the work location or work environment that each group of workers are responsible for. The protective equipment wearing determination unit 220 according to an embodiment determines whether protective equipment required to be worn for each group of workers has been correctly worn.

To this end, reference may be made to a database (not shown) that stores information about protective equipment required for each group of workers.

Through the above analysis, a worker who has incorrectly worn protective equipment may be identified.

When there is a worker who has incorrectly worn protective equipment, a warning message may be sent into the work space or construction site of the worker.

The safety/risk factor determination unit 230 identifies a work space for each group of workers, determines at least one safety factor required to be disposed in the corresponding work space, and recognizes whether the corresponding safety factor has been actually provided. Furthermore, the safety/risk factor determination unit 230 serves to provide notification of at least one risk factor for each work space.

According to an embodiment, a risk factor for each group of workers and a safety factor required to be disposed for the group of workers may be as follows:

TABLE 2

| | Color of | | | |
|---|---|---|---|---|
| | Safety | | Safety | |
| Group | Helmet | Main Work | Factor | Risk Factor |
| B | red | welding | powder fire | flammable |
| | | | extinguisher | material warning |
| C | pink | structure | halogen | electric shock |
| | | construction | compound | risk |
| F | black | power | carbon | acute toxicity |
| | | construction | dioxide fire | |
| | | | extinguisher | |

In the above table, the color of a safety helmet represents an example of an identifier for identifying a group of workers, and the description of a safety factor and a risk factor for each group of workers is only an example. In other words, the type of work may vary depending on each group of workers. There is at least one safety factor that needs to be provided in a corresponding work space for each type of work to be performed, and a warning about at least one risk factor is required.

The safety/risk factor determination unit 230 identifies the safety factor and the risk factor through the database, and determines whether, for each group of workers, there is a safety factor in a work space where a corresponding worker works. If there is no safety factor, warning information informing the worker of a risk may be provided. The warning information may be provided through various methods, such as voice notification via a speaker and visual notification via a warning light.

Furthermore, for a risk factor, notification of corresponding information may be provided to a work space for each worker. The work space may be based on a concept including a space within a preset radius range for each worker.

In the foregoing description, the recognition of a worker, the recognition of protective gear or a safety helmet, the recognition of the color of the safety helmet, the recognition of protective equipment worn by each worker, and the recognition of a safety factor provided in a work space may be performed through image analysis based on a machine learning model. For example, each object is modeled through the image labeling of a feature information like each worker, protective gear, safety helmet, protective equipment, safety factor, etc., and it is detected whether there is a previously labeled model in a recognized image.

Furthermore, in image analysis or image labeling, the machine learning model may be trained with at least two data sets having different environments except for the feature information in the image. For example, a data set in a general environment (e.g., a daytime zone from noon to 6 p.m.) and a data set in a dark environment (e.g., a nighttime zone from 8 p.m. to 2 a.m.) may be merged together and then utilized. Since machine learning is performed using both the image data set in the general environment and the image data set in the dark environment, each recognition target object may be recognized regardless of the environment in which the object is placed.

Furthermore, since general object recognition shows only scores exceeding a reference value, detection is not accurately performed in environments such as an environment in which there is noise or the like. In one embodiment of the present invention, object recognition is enabled even in the presence of noise by applying Bayesian inference additionally.

The work area departure determination unit 240 serves to determine whether each worker departs from a work area for each group of workers identified by the worker recognition unit 210. Information about a work area for each group of workers may be stored in a database. The work area departure determination unit 240 may determine whether each worker departs from the work area for each group of workers based on the information stored in the database.

The location of each worker may be indirectly determined through information about the image acquisition location of the image acquisition device 100.

If there is a worker who departs from a work area, a warning message requesting the worker to return to a correct work area in a construction site may be sent.

Meanwhile, there may be a worker who departs from a limited work area (a first work area) and then performs another type of work in another work area (a second work area). In this case, protective equipment required to be worn for the first work area and the protective equipment required to be worn for the second work area may be different from each other. In this case, the protective equipment that is worn by the worker who works after moving to the second work area is determined. If protective equipment required to be worn has not been provided in the second work area, a warning message may be sent. The warning message may additionally include information about protective equipment required to be worn, and may be sent to the terminal of the corresponding worker or be sent in the form of being broadcast in the work area.

If it is determined that the worker has all the protective equipment required to be worn for the second work area, the warning message may not be sent.

For example, assuming that a specific worker departs from the first work area and enters the second work area, a warning message may be basically provided when the time for which the worker departs from the first work area is equal to or longer than a preset time. The warning message may be a warning message instructing the worker to return to the first work area when the time elapsed after the departure from the first work area is shorter than a threshold time, and may be a warning message requesting the worker to wear protective equipment required for the second work area when the time is equal to or longer than the threshold time. The reason for this is that the worker may be considered to simply depart from the work area when a short time has elapsed after the departure from the first work area while the worker may be considered to perform another type of work in the second work area when a time longer than the threshold time has elapsed after the departure from the work area.

Meanwhile, when it is determined through image analysis that the worker has worn all the protective equipment required for the second work area, the warning message may not be provided.

At least some of the operations of the analysis server 200 described above may be performed by the image acquisition device 100 on its own. For example, edge AI, which performs machine learning on its own in a hardware device or an embedded system, may be executed in the image acquisition device 100.

When all the operations of the analysis server 200 are performed by the image acquisition device 100 on its own, the above-described configuration of the analysis server 200 may be viewed as being integrated with the image acquisition device 100.

According to an embodiment of the present invention, workers working in a construction site may be grouped, protective equipment required to be worn for each group of workers may be determined, and whether each worker has worn the protective equipment required to be worn for the group of workers may be determined.

Furthermore, according to an embodiment of the present invention, in a construction site, safety and risk factors for each group of workers may be determined, each work area may be recognized, and a departure from the work area may be determined.

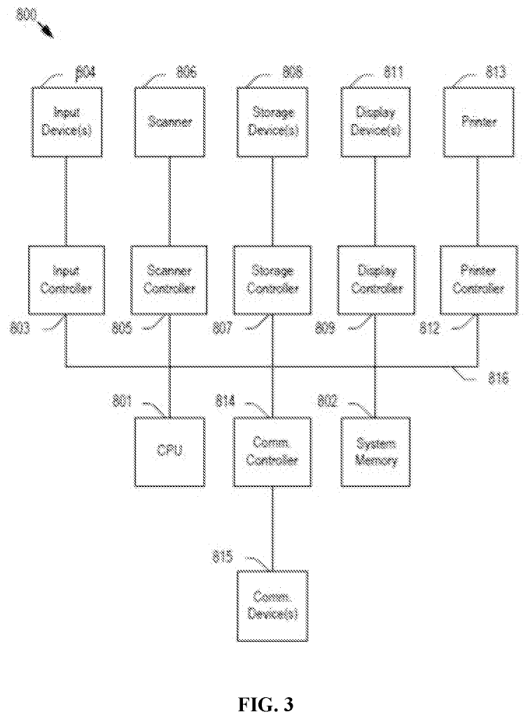

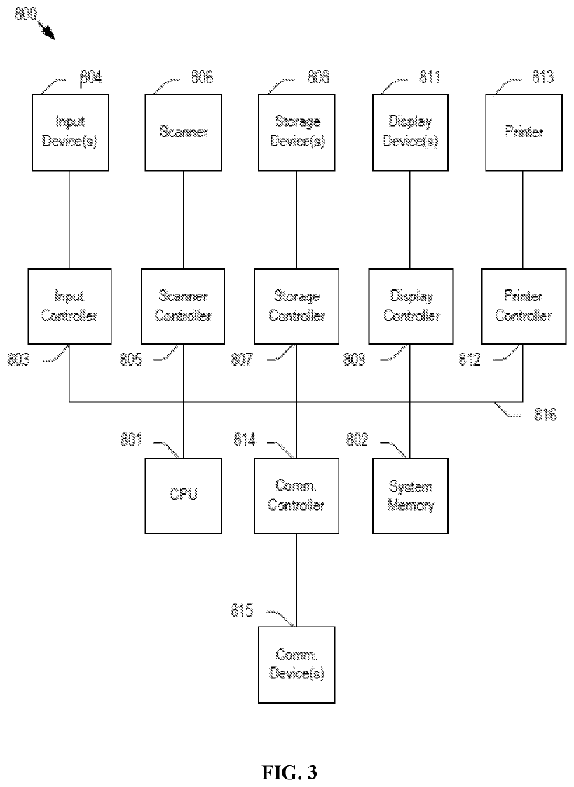

FIG. 3 shows a schematic diagram of a system 800 for implementing one or more aspects of the present disclosure. It will be understood that the functionalities shown for system 800 may operate to support various embodiments of the image acquisition device 100 shown in FIG. 1—although it shall be understood that the image acquisition device may be differently configured and include different components. As illustrated in FIG. 3, system 800 includes a central processing unit (CPU) 801 that provides computing resources and controls the computer. CPU 801 may be implemented with a microprocessor or the like, and may also include a graphics processor and/or a floating-point coprocessor for mathematical computations. System 800 may also include a system memory 802, which may be in the form of random-access memory (RAM) and read-only memory (ROM).

A number of controllers and peripheral devices may also be provided, as shown in FIG. 3. An input controller 803 represents an interface to various input device(s) 804, such as a keyboard, mouse, or stylus. There may also be a scanner controller 805, which communicates with a scanner 806. System 800 may also include a storage controller 807 for interfacing with one or more storage devices 808 each of which includes a storage medium such as magnetic tape or disk, or an optical medium that might be used to record programs of instructions for operating systems, utilities and applications which may include embodiments of programs that implement various aspects of the present invention. Storage device(s) 808 may also be used to store processed data or data to be processed in accordance with the invention. System 800 may also include a display controller 809 for providing an interface to a display device 811, which may be a cathode ray tube (CRT), a thin film transistor (TFT) display, or other type of display. System 800 may also include a printer controller 812 for communicating with a printer 813. A communications controller 814 may interface with one or more communication devices 815, which enables system 800 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 816, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

The foregoing description of the present invention is intended for illustration. It can be understood by those of ordinary skill in the art to which the present invention pertains that the above-described embodiments may be easily modified into other specific forms without changing the technical spirit or essential features of the present invention. Accordingly, it should be understood that the above-described embodiments are illustrative but not restrictive in all respects. For example, each component described as being of a single type may be implemented in a distributed form. Likewise, components described as being of a distributed type may also be implemented in an integrated form.

The scope of the present invention is defined by the attached claims, and all alterations or modifications derived from the meanings and scopes of the claims and their equivalents should be construed as being encompassed in the scope of the present invention.

What is claimed is:

1. A method for determining a risk in a construction site based on image analysis by an analysis server comprising a processor and a memory comprising one or more sequences of instructions which, when executed by the processor, causes steps to be performed comprising:
storing an image in the memory, taken in a construction site, from an image acquisition device;
extracting a feature information from the image and classifying as each group of workers using the feature information based on a machine learning model;
determining whether at least one of a safety factor and a risk factor required to be disposed in a work space has been disposed based on a type of work for each group of workers in the image, if there is no the safety factor or there is the risk factor in the work space, preparing a warning information so that the worker is able to perceive the warning information; and
determining whether there is a departure from a work area for each group of workers based on information about the work area for each group of workers in the image, if a worker who departs from a first work area, moves to a second work area, preparing a message so that the worker wears protective equipment required according to the work area,
wherein the protective equipment is required differently depending on the work area.

2. The method of claim 1, wherein the feature information includes at least one of a color of protective gear worn by the worker or a color of protective equipment in the image.

3. The method of claim 1, wherein the machine learning model is trained with at least two data sets having different environments except for the feature information in the image.

4. A system for determining a risk in a construction site based on an image analysis by an analysis server, the analysis server comprising:
a processor and
a memory comprising one or more sequences of instructions which, when executed by the processor, causes steps to be performed comprising:
storing an image in the memory, taken in a construction site, from an image acquisition device;
extracting a feature information from the image and classifying as each group of workers using the feature information based on a machine learning model;
determining whether at least one of a safety factor and a risk factor required to be disposed in a work space has been disposed based on a type of work for each group of workers in the image, if there is no the safety factor or there is the risk factor in the work space, preparing a warning information so that the worker is able to perceive the warning information; and
determining whether there is a departure from a work area for each group of workers based on information about the work area for each group of workers in the image, if a worker who departs from a first work area, moves to a second work area, preparing a message so that the worker wears protective equipment required according to the work area,
wherein the protective equipment is required differently depending on the work area.
